(19) United States
(12) Patent Application Publication
(10) Pub. No.: US 2005/0069163 A1
(43) Pub. Date: Mar. 31, 2005

(54) Hearing aid

(76) Inventor: Anna O'Brien, Bern (CH)

Correspondence Address: DYKEMA GOSSETT PLLC, FRANKLIN SQUARE, THIRD FLOOR WEST, 1300 I STREET, NW, WASHINGTON, DC, 20005, US

(21) Appl. No.: 10/492,560

(22) PCT Filed: Oct. 8, 2002
(86) PCT No.: PCT/EP02/11241

(30) Foreign Application Priority Data
Oct. 15, 2001 (EP) 01610107.3

(51) Int. Cl. H04R 25/00

(52) U.S. Cl. 381/314; 381/315

(57) ABSTRACT

The invention relates to a method of adjusting a hearing aid in a fitting situation where the hearing impaired person is present, where sound is provided through one or more speakers, where the hearing aid is placed in/on the ear of the hearing impaired in the intended working position, where the sound signal is provided and where the hearing aid is producing a microphone level and/or frequency output signal in correspondence to its actual working position and in response to the sound provided, where this output signal is provided to the fitting software during the fitting process.

### AREA OF THE INVENTION

The invention relates to the area of hearing aid fitting. More particularly the invention relates to the area of calibrating the fitting equipment and the hearing aid in the fitting situation.

### BACKGROUND OF THE INVENTION

Today the fitting situation where a hearing aid is fitted to a hearing impaired person is often carried out using playback of sound environments recorded in natural situations in order to obtain the best fit of the hearing aid to the real world. Sometimes a simultaneous playback of synchronized still pictures or live pictures is performed, which is enhancing the hearing impaired persons experience of the listening situation. The latter is however only intended to improve the effect of real world sound. When performing the fine tuning using CD sound stimuli, it is important that the level of the sound adjusted is correct, i.e. that the level of the stimulus going into the hearing instrument and to which the person responds actually corresponds to the level adjusted by the dispenser in the software.

It is well known to perform the calibration of the system by placing the hearing instrument approximately in the position of the person to be fitted and afterwards adjusting the sound level to match the actual intended situation to be simulated. It has however shown that this method does not perform satisfactory, as the level may be to low in some frequency areas and to high in others, which may lead to an overall to low level with a lack of perception as a consequence for the hearing impaired.

Therefore there is a need of improving the calibration of the microphone in these situations.

The objective of the present invention is to provide a method, an equipment and a software by which the sound level actually received by the hearing instrument and processed for the hearing impaired to a higher degree corresponds to the sound levels displayed and adjusted by the dispenser in the software of the fitting equipment.

### SUMMARY OF THE INVENTION

According to the invention this is achieved by means of the method as defined in claim 1.

By performing the calibration in the actual operating position of the hearing aid the ear, head and body influence on the sound transfer function is taken into consideration. By doing this online or real-time during the fitting process the level of actual signals is taken into account and can therefore be of significant importance in especially fine-tuning of the hearing aid. This will improve the fitting and thereby the actual performance of the hearing aid after the fitting has been completed.

In one embodiment the invention can be performed by making adjustments to the actual sound output during playback, thereby compensating for the influences on the sound transfer function by the hearing aid user. In another embodiment the invention can be performed by providing a visual indication on the display used by the hearing aid professional hereby allowing him/her to make the adjustment of the hearing aid in the appropriate way.

The invention further relates to a fitting equipment capable of performing the invention in connection with a hearing aid adapted for delivering an microphone output level signal.

According to the invention this is achieved by means of fitting equipment as defined in claim 6.

By such fitting equipment in combination with a hearing aid as mentioned above the same advantages as mentioned in connection with the method can be achieved.

Still further the invention relates to a fitting software for use in a fitting equipment as described above.

According to the invention this is achieved by means of software as defined in claim 8.

By such fitting software in combination with a computer and a hearing aid as mentioned above the same advantages as mentioned in connection with the method can be achieved. The software may be stored on a machine readable medium, e.g. a diskette, a CD-ROM, a flash memory, a HDD or the like or it may be stored directly in the memory of the PC and/or the fitting equipment.

The invention will be explained more detailed in the following description of a preferred embodiment with reference to the drawing.

### BRIEF DESCRIPTION OF THE DRAWINGS

FIG. 1 is a schematic block diagram depicting elements of a system using the principles of the method according to the invention.

FIG. 2 is a schematic diagram showing elements of a hearing aid and programming equipment

FIG. 3 is a schematic diagram showing a hearing aid connected to a programming equipment, where the level output from the hearing aid is indicated on the display of the programming equipment.

### DESCRIPTION OF A PREFERRED EMBODIMENT

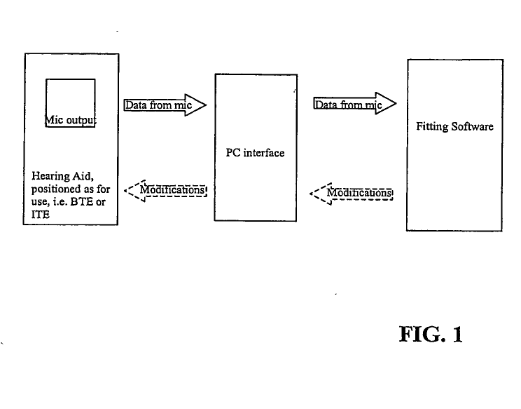

Referring to FIG. 1 a fitting system for fitting a hearing aid comprises a computer having suitable fitting software installed. The computer comprises a display. The computer and the hearing aid are interconnected by means of wireless communication or wires and an interface module keeping the computer and the hearing aid galvanically separated. The interconnection provides for data transfer to and from the hearing aid in a manner controllable by means of the computer.

The hearing aid is designed with a level meter capable of determining the microphone output frequency and/or level and being in connection with the terminals for communication with the computer.

During fitting the microphone output is displayed and the hearing aid professional may based on this information adjust the hearing aid parameters accordingly. Alternatively, the information on the microphone output may be used within the software to adjust the level of the presented sound to a predefined level.

It should be noted that the modifications are optional; the fitter will decide based on the wearer's response what any modifications to the hearing instrument response should be.

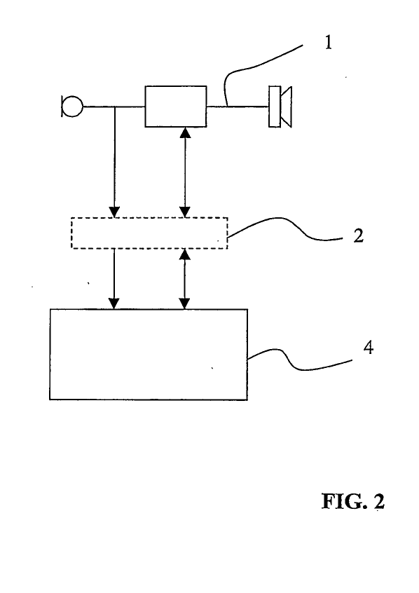

From FIG. 2 the essential elements of the hearing aid signal path 1 appears. It is indicated that the microphone level signal is a signal obtained between the microphone and the signal processor. It could in fact as well be obtained form the signal processor. The signal is transmitted to the interconnecting programming device 2 and from there to the programming computer 4 running a fitting software.

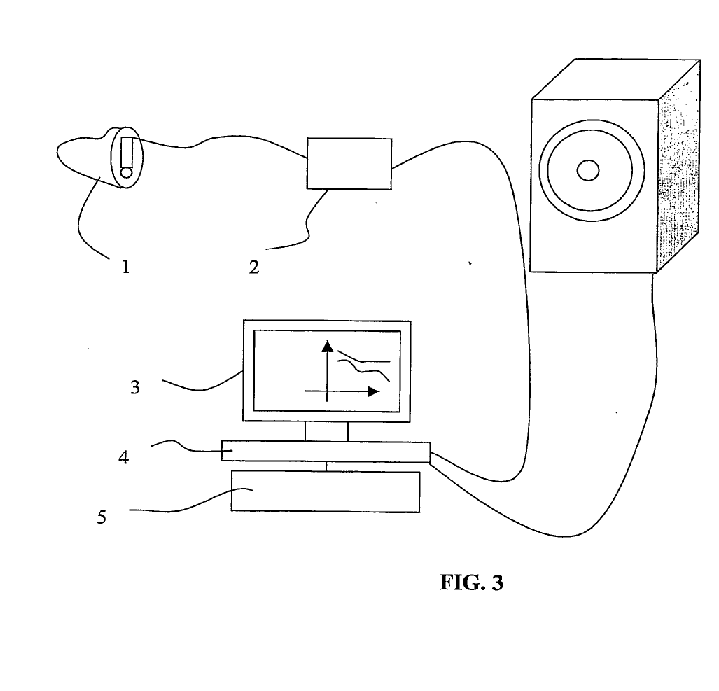

From FIG. 3 the entire system becomes apparent. The hearing aid 1 is connected to the interconnecting programming device 2 and from there to a programming computer 4 having a display 3 and a keyboard 5. The computer is controlling a speaker generating sound. On the display to curves are indicated where one represents the actual microphone level.

1. A method of adjusting a hearing aid in a fitting situation where the hearing impaired person is present, where sound is provided through one or more speakers, where the hearing aid is placed in/on the ear of the hearing impaired in the intended working position, where the sound signal is provided and where the hearing aid is producing a microphone level and/or frequency output signal in correspondence to its actual working position and in response to the sound provided, where this output signal is provided to the fitting software during the fitting process and where the microphone output is used to adjust the level and/or spectrum of the sound produced through the loud speaker/s.

2. A method according to claim 1, where the microphone output is used to produce a visual indication of the level and/or frequency on the display used by the hearing aid professional during the fitting process.

3. A method according to claim 1, where the output level signal is analyzed for both intensity content and frequency content.

4. A method according to claim 3, where the intensity and the frequency content of the signal is indicated on the display used by the hearing aid professional.

5. A fitting equipment for performing the method according to any of the preceding claims on a hearing aid capable of providing an microphone output level and/or frequency signal to the fitting equipment, where the equipment is adapted for indicating the microphone output during the fitting procedure.

6. A fitting equipment according to claim 5, where the equipment is adapted for producing a visual indication of the level on the display used by the hearing aid professional during the fitting process.

7. A fitting software for use in connection with a fitting equipment according to any of the previous claims, where the software is adapted for producing an output for the fitting equipment indicating the microphone output level during the fitting procedure.

8. A fitting software according to claim 7, where the software is adapted for producing a signal enabling a visual indication of the level on the display of the fitting equipment used by the hearing aid professional during the fitting process.
